(19) United States
(12) Patent Application Publication
(10) Pub. No.: US 2005/0255729 A1
(43) Pub. Date: Nov. 17, 2005

(54) Device for holding junction blocks in position

(75) Inventors: Franck Da Silva, Saint Savin (FR); Benoit Jourdan, Lyon (FR)

Correspondence Address: OLIFF & BERRIDGE, PLC, P.O. BOX 19928, ALEXANDRIA, VA, 22320, US

(73) Assignee: ABB ENTRELEC, Villeurbanne (FR)

(21) Appl. No.: 11/119,833

(22) Filed: May 3, 2005

(30) Foreign Application Priority Data
May 12, 2004 (FR) 04.05140

(51) Int. Cl. H01R 13/62

(52) U.S. Cl. 439/153

(57) ABSTRACT

Device for holding in position junction blocks which are fixed by a foot onto a support of the rail type, particularly to form a terminal strip, and which comprises a connecting part equipped with immobilizing means at its two ends able to accommodate, between these two ends, a determined number of junction blocks pressed one against the other in a row.

### BACKGROUND OF THE INVENTION AND DESCRIPTION OF THE PRIOR ART

The present invention relates to a device for holding electrical junction blocks in position.

A terminal strip for connecting electrical conductors is commonly made up of a collection of junction blocks arranged side by side in a row, the junction blocks being fixed to a support rail that allows the alignment to be maintained.

Alignment may also be facilitated by the presence of studs on the junction blocks which can be housed in cavities of corresponding shape on the adjacent junction block in the row.

Conducting elements such as shunts which allow several poles of the terminal strip to be maintained at the same potential, or plugs allowing a pole to be connected to a given electrical circuit may be connected to the terminal strips thus formed. A shunt or a plug comprising several pins must be used in the face of several terminals spaced apart by a determined spacing.

Furthermore, complementary elements such as caps are also used to protect the terminal strip, at least in part. A cap can be fitted only over a row of junction blocks of determined length.

However, junction blocks have some clearance between them particularly as a result of their being arranged on the rail by hand, as a result of defects of alignment, or as a result of molding residue on the faces of the blocks or on their studs that allow them to be kept aligned. This clearance is uneven, the blocks not being arranged uniformly at a determined spacing, and the length of a terminal strip thus formed is random and exceeds the sum of the size of the junction blocks parallel to the support rail.

That makes the use of the plugs, shunts or other devices intended to interact with several junction blocks simultaneously difficult, the blocks having to be held in place by hand at least during the fitting phase, and then subjecting the device to stresses after assembly.

### SUMMARY OF THE INVENTION

It is an object of the present invention to solve the technical problem that consists in ensuring a constant separation between the junction blocks of a terminal strip by providing a device allowing the junction blocks to be clamped together and at the same time more or less eliminating the clearance between these blocks while at the same time guaranteeing limited additional space occupation.

To this end, the subject of the present invention is a device for holding in position junction blocks which are fixed by a foot onto a support of the rail type, particularly to form a terminal strip, and which comprises a connecting part equipped with immobilizing means at its two ends able to accommodate, between these two ends, a determined number of junction blocks pressed one against the other in a row.

The device, distinct from the support, may be used with the known rail-type supports.

Advantageously, the connecting part consists of a plate more or less parallel to the support rail.

According to one embodiment, the immobilizing means comprise at least one wedge intended to collaborate with a wall of a junction block situated at one end of the row.

Advantageously, its dimensions perpendicular to the support rail allow it to be housed in the space between the foot of the junction blocks and the support rail.

According to one embodiment, the device comprises catching means at each of its ends, allowing it to be fixed to the junction blocks situated at the two ends of the row.

According to one possibility, the catching means comprise at least one moving hook able to move outward as the junction blocks are introduced between the immobilizing means, then to become housed in a cavity in the end junction block in the row.

According to another possibility, the catching means comprise at least one fixed hook, secured to the immobilizing means, the row of junction blocks being compressed as the junction blocks are introduced between the immobilizing means, the hook becoming housed in a cavity in the end junction block after insertion.

Advantageously, the parts of the device which are situated at the ends, outside of the part accommodating the junction blocks, are of dimensions, perpendicular to the support rail, that allow them to be housed under a separating end plate of the terminal strip formed by the junction blocks, and of dimensions, parallel to the support, smaller than those of this end plate.

### BRIEF DESCRIPTION OF THE DRAWINGS

The present invention will be better understood from reading the following description, with reference to the attached drawing that depicts two embodiments of a device for holding in position according to the invention.

FIG. 1 is a perspective view thereof according to a first embodiment.

FIG. 2 is a side view of the device of FIG. 1 with, in part section, a schematic depiction of a terminal strip held by the device.

FIG. 3 is a side view of the device of FIG. 1 in section on a larger scale with one terminal strip held.

FIG. 4 is a detailed view thereof in section according to a second embodiment.

### DESCRIPTION OF THE PREFERRED EMBODIMENTS

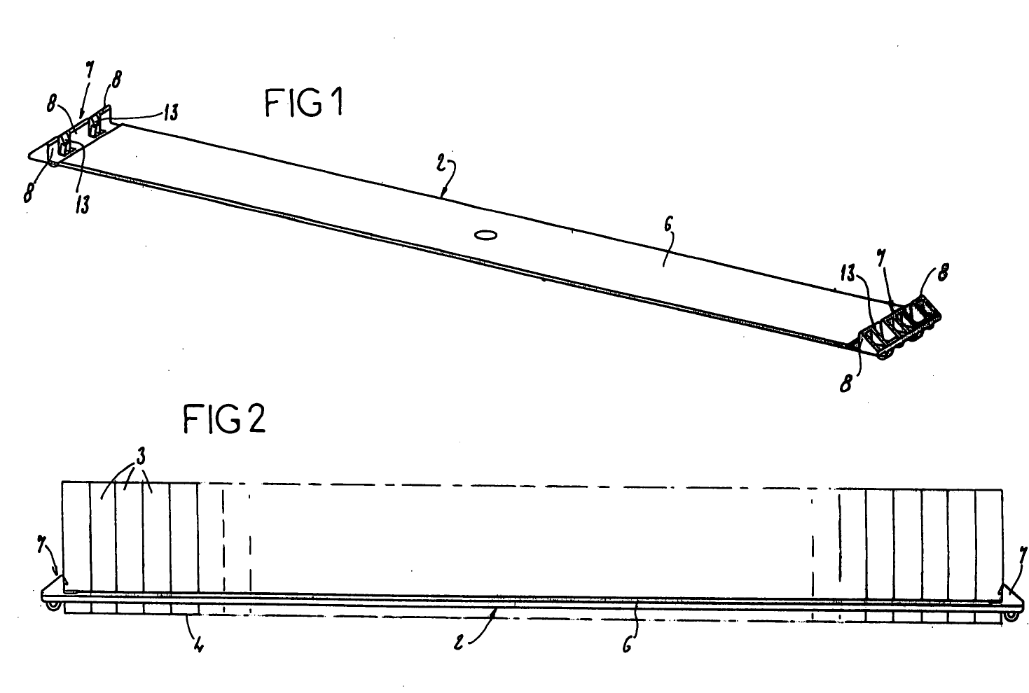

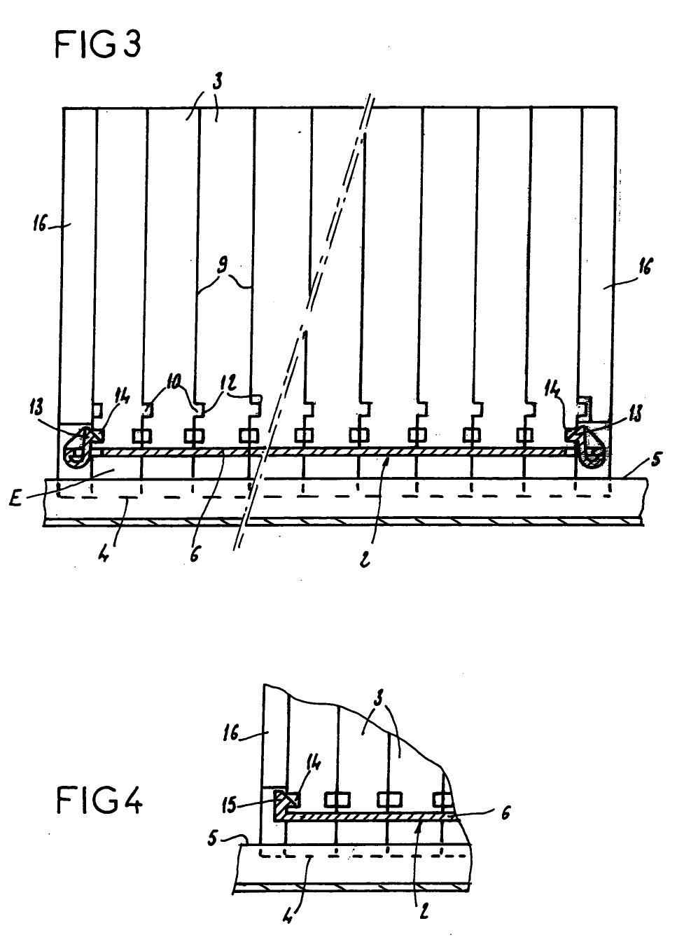

As depicted in FIGS. 1 to 3, according to a first embodiment, a device 2 for holding in position junction blocks 3 intended to be fixed by a foot 4 onto a support of the rail type 5 comprises a connecting part consisting of a plate 6 more or less parallel to the support rail 5, equipped with immobilizing means 7 at its two ends, these consisting of wedges 8 intended to collaborate with a wall of a junction block 3 situated at one end of the row.

The immobilizing means 7 situated at the two ends allow a determined number of junction blocks 3 pressed one against another in a row to be housed between these two ends.

The junction blocks 3 are, in particular, joined together in an alignment in order to form a terminal strip allowing a collection of poles performing determined functions to be held together.

Each junction block 3 comprises, on one of its face 9 perpendicular to the support rail 5, a stud 10 intended to be housed in a cavity 12 of corresponding shape formed in the face opposite belonging to the adjacent junction block 3 in the alignment.

The plate 6 has a width perpendicular to the support rail 5 that allows it to be housed between the foot 4 of the junction blocks 3 and the support rail 5 on which the junction blocks 3 are fixed, a space E being present between the foot and the rail in the junction blocks of known type. The device, separate from the support, can thus be used with known rail-type supports and does not require a special type of support.

The device 2 additionally comprises, at each of its ends, catching means 13 allowing it to be fixed to end junction blocks 3 in the alignment.

The catching means consist of moving hooks 13 which can move outwards as the junction blocks 3 are inserted between the wedges 8, then become housed in a cavity 14 in the end junction block 3.

According to a second embodiment depicted in FIG. 4, the device comprises the same elements except that the catching means consist of fixed hooks 15, secured to the immobilizing means, the row of junction blocks being compressed as the junction blocks are inserted between the immobilizing means, the hook becoming housed in a cavity in the end junction block 3 after insertion.

According to the two embodiments depicted in the figures, the wedges 8 and the hooks 13 or 15 situated at the ends of the plate have dimensions perpendicular to the rail that allow them to be housed under end plates 16 bounding at each end the terminal strip formed by the alignment of the junction blocks contained on the plate.

Furthermore, the wedges 8 and the hooks 13 or 15 have a dimension in the direction of the rail more or less equal to that of an end plate, allowing them thus not to protrude from the end plate 16 when the latter is in position. In this way, it is possible for other junction blocks 3 or other elements to be fixed to the rail 5 directly in contact with the end plates that bound the terminal strip.

As goes without saying, the invention is not restricted to the preferred forms of embodiment described hereinabove by way of nonlimiting example; on the contrary, it encompasses all variant embodiments thereof that fall within the scope of the claims hereinafter.

1. A device for holding in position junction blocks which are fixed by a foot onto a support of the rail type, particularly to form a terminal strip, and which comprises a connecting part equipped with immobilizing means at its two ends able to accommodate, between these two ends, a determined number of junction blocks pressed one against the other in a row.

2. The device as claimed in claim 1, wherein the connecting part consists of a plate more or less parallel to the support rail.

3. The device as claimed in claim 1, wherein the immobilizing means comprise at least one wedge intended to collaborate with a wall of a junction block situated at one end of the row.

4. The device as claimed in claim 1, wherein its dimensions perpendicular to the support rail allow it to be housed in the space between the foot of the junction blocks and the support rail.

5. The device as claimed in claim 1, and which comprises catching means at each of its ends, allowing it to be fixed to the junction blocks situated at the two ends of the row.

6. The device as claimed in claim 5, wherein the catching means comprise at least one moving hook able to move outward as the junction blocks are introduced between the immobilizing means, then to become housed in a cavity in the end junction block in the row.

7. The device as claimed in claim 5, wherein the catching means comprise at least one fixed hook, secured to the immobilizing means, the row of junction blocks being compressed as the junction blocks are introduced between the immobilizing means, the hook becoming housed in a cavity in the end junction block after insertion.

8. The device as claimed in claim 1, characterized in that the parts of the device which are situated at the ends, outside of the part accommodating the junction blocks, are of dimensions, perpendicular to the support rail, that allow them to be housed under a separating end plate of the terminal strip formed by the junction blocks, and of dimensions, parallel to the support, smaller than those of this end plate.
